(19) United States
(12) Patent Application Publication
(10) Pub. No.: US 2012/0195519 A1
(43) Pub. Date: Aug. 2, 2012

(54) Method of Generating Corrected Image Data and Display Apparatus

(76) Inventor: Yoshiaki Horikawa, Tokyo (JP)

(21) Appl. No.: 13/443,488

(22) Filed: Apr. 10, 2012

Related U.S. Application Data
(63) Continuation of application No. PCT/JP2010/067018, filed on Sep. 22, 2010.

(30) Foreign Application Priority Data
Oct. 27, 2009 (JP) JP2009-246723

(51) Int. Cl. G06K 9/40; G09G 3/36; G09G 5/00

(52) U.S. Cl. 382/255; 382/254; 345/619; 345/87

(57) ABSTRACT

There is provided a method of generating corrected image data and a display apparatus which is capable of displaying a pre-corrected image which is corrected in advance, which enables to carry out diopter adjustment for farsightedness due to old age at a practically sufficient level.

In the method of generating corrected image data, the pre-corrected image data consists of amplitude information and phase information, is generated. The display apparatus includes a processing section which generates the pre-corrected image data consists of the amplitude information and the phase information, by a predetermined method of generating corrected image data, and a display section which controls and displays the amplitude information and the phase information of the corrected image data which has been generated.

### CROSS-REFERENCE TO RELATED APPLICATION

The present application is a continuation of PCT International Patent Application No. PCT/JP2010/067018 filed on Sep. 22, 2010, which is based upon and claims the benefit of priority from the prior Japanese Patent Application No. 2009-246723 filed on Oct. 27, 2009, each of which is expressly incorporated herein in its entirety by reference thereto.

### BACKGROUND OF THE INVENTION

1. Field of the Invention

The present invention relates to a method of generating corrected image data and a display apparatus.

2. Description of the Related Art

As a display apparatus (display) which displays images and characters, a liquid crystal display and a plasma display are available. However, diopter adjustment is not available in these display apparatuses. With the aging of society, there is an increase in the number of elderly people having farsightedness due to old age (presbyopia), and a display apparatus, particularly a flat-panel display (hereinafter, ‘FPD’) which is capable of diopter adjustment, has been sought. Particularly, due to widespread use of mobile telephones and digital cameras, there is an increase in the number of occasions of looking at a display by the FDP outdoor.

However, it is extremely cumbersome to put on or take off reading glasses every time at the time of looking at the FPD of a mobile telephone or a digital camera. In a digital single-lens reflex camera, the FDP is used as a live-view monitor. In the digital single-lens reflex camera, it is not practical to put on or take off reading glasses every time for looking the live-view monitor while looking at a distant object. Apart from this, even at the time of observing a liquid-crystal screen of a personal computer (PC), it is cumbersome to put on or take off reading glasses.

An FDP which solves such problems has not existed. Such problems have been pointed out recently, and in Japanese Patent No. 3552413, a method of displaying a corrected image to which an edge enhancement is performed. Moreover, in Japanese Patent Application Laid-open Publication No. 2007-128355, a method of using pre-corrected image generated by an inverse matrix of Toeplitz matrix has been proposed.

### SUMMARY OF THE INVENTION

In the method of edge enhancement according to Japanese Patent No. 3552413, although display information is made somewhat easily visible, it is not possible to restore a defocus image because the edge enhancement in the Japanese Patent is not a correction using information of defocus which is a cause of blurring of an image.

Whereas in Japanese Patent Application Laid-open Publication No. 2007-128355, the correction in which the information of defocus is used is carried out. An image is corrected based on Toeplitz matrix constituted by a point-spread function due to insufficient focusing adjustment of an eye. However, since no complex number appears in corrected image data when Toeplitz matrix is used, as a result of the correction, a level of edge enhancement is the same as in Japanese Patent No. 3552413. The effect when used practically could not be said to have reached up to the level of practical use.

The present invention has been made in view of the abovementioned circumstances, and an object of the present invention is to provide a method of generating corrected image data which generates a pre-corrected image and to provide a display apparatus which can display the pre-corrected image, in which it is possible to carry out diopter adjustment to a practically sufficient level.

To solve the abovementioned issues and to achieve the object, a method of generating corrected image date according to the present invention includes generating a pre-corrected image data consists of amplitude information and phase information.

In the method of generating corrected image data according to the present invention, it is preferable that a correction function which is used for generating the pre-corrected image data is a correction function of an optical system.

In the method of generating corrected image data according to the present invention, it is preferable that the correction function is inverse number of a transfer function of defocus.

In the method of generating corrected image data according to the present invention, it is preferable that the correction function is the Wiener filter of a transfer function of defocus.

In the method of generating corrected image data according to the present invention, it is preferable that the optical system is an ocular optical system.

A display apparatus according to the present invention includes a processing section which generates corrected image data which includes amplitude information and phase information by any one of the abovementioned methods of generating corrected image data, and a display section which controls and displays the amplitude information and the phase information of the corrected image data which have been generated.

In the display apparatus according to the present invention, it is preferable that the display section is a display device composed of a liquid crystal.

In the display apparatus according to the present invention, it is preferable that the display device is illuminated via a scattering plate.

In the display apparatus according to the present invention, it is preferable that a coherent illuminated area is larger than 1 mm.

In the display apparatus according to the present invention, it is preferable that a display source of the display device is a solid light source.

In the display apparatus according to the present invention, it is preferable that the light source is an LED.

In the display apparatus according to the present invention, it is preferable that the light source is a laser.

In the display apparatus according to the present invention, it is preferable that the display apparatus includes a speckle reducing mechanism which reduces speckle.

The method of generating corrected image data and the display apparatus according to the present invention show effects that it is possible to generated a pre-corrected image in which it is possible to carry out diopter adjustment to a practically sufficient level, and to display the pre-corrected image.

### BRIEF DESCRIPTION OF THE DRAWINGS

FIG. 1 is a diagram showing an example of a display image, and is also a display image used for generating a corrected image data according to a first embodiment of the present invention;

FIG. 2 is a diagram showing a focal position of an observer having farsightedness due to old age and a distance of distinct vision at which the image shown in FIG. 1 is placed;

FIG. 3 is a diagram showing a defocus image which the observer having farsightedness due to old age shown in FIG. 2 sees when the image shown in FIG. 1 is placed at the distance of distinct vision;

FIG. 4 is a diagram showing an image seen when the observer having farsightedness due to old age shown in FIG. 2 sees a pre-corrected image generated by the Wiener filter based on the image shown in FIG. 1. This image, in which defocus is corrected, becomes in focus and equivalent to the image in FIG. 1;

FIG. 5 is a diagram showing an amplitude component of the pre-corrected image which has been generated by the Wiener filter based on the image shown in FIG. 1;

FIG. 6 is a diagram showing a phase component of the same pre-corrected image. The phase component is indicated by shading;

FIG. 7 is a side view showing an arrangement of a liquid-crystal device which can display the amplitude component and the phase component simultaneously;

FIG. 8 is a block diagram showing a configuration of a control system of the liquid-crystal device shown in FIG. 7;

FIG. 9 is a conceptual diagram showing a state in which coherent image-formation is realized;

FIG. 10 is a conceptual diagram showing an arrangement with a scattering plate;

FIG. 11 is a diagram showing an arrangement of a display apparatus according to a second embodiment;

FIG. 12 is a front view showing a arrangement of a display apparatus according to a third embodiment of the present invention; and

FIG. 13 is a side view showing an arrangement of the display apparatus according to the third embodiment.

### DETAILED DESCRIPTION OF THE INVENTION

Exemplary embodiments of a method of generating corrected image data and a display apparatus according to the present invention will be described below in detail while referring to the accompanying diagrams. However, the present invention is not restricted to the embodiments described below. In the following description, although different styles of script (italic and standard (not italic)) have been used for parameters such as I(x, y), the meaning of the parameters is same.

### First Embodiment

Firstly, a generation of a pre-corrected image which is corrected in advance will be described below.

When an intensity of an image observed by eyes (hereinafter, ‘observed image’) is I(x, y), and an amplitude is i(x, y), I(x, y) will be expressed as follows. Here, x and y are two-dimensional coordinates of the image.

I(x, y)=|i(x, y)|²

Moreover, when an intensity of an image displayed on a display apparatus (hereinafter, ‘display image’) is O(x, y), and an amplitude of display image is o(x, y), O(x, y) will be expressed as follows.

O(x, y)=|o(x, y)|²

Furthermore, when a point-image response function (hereinafter, ‘IRF’, which is amplitude) of an ocular optical system is h(x, y), coherent image formation is described with the following expression (1), which is convolution.

i(x, y)=h(x, y)*o(x, y)=∫∫h(x′, y′)o(x−x′, y−y′)dx′dy′ (1)

Since the observed image is an intensity (square of an amplitude), I(x, y) becomes

I(x, y)=|i(x, y)|²=|h(x, y)*o(x, y)|²

Here, i(x, y), h(x, y), and o(x, y) are expressed in the following expressions (2), (3), and (4) respectively according to Fourier transform. Fi(u, v), Fh(u, v), and Fo(u, v) are Fourier transforms of i(x, y), h(x, y), and o(x, y) respectively. Moreover, although Fh(u, v) is Fourier transform of IRF, this is also a CTF (coherent transfer function).

Fi(u, v)=FT[i(x, y)]=∫∫i(x, y)exp[−j2π(ux+vy)]dxdy (2)

Fh(u, v)=FT[h(x, y)]=∫∫h(x, y)exp[−j2π(ux+vy)]dxdy (3)

Fo(u, v)=FT[o(x, y)]=∫∫o(x, y)exp[−j2π(ux+vy)]dxdy (4)

Then, Fi(u, v) can be expressed as a product of Fh(u, v), and Fo(u, v) as shown in expression (5).

Fi(u, v)=Fh(u, v)Fo(u, v) (5)

When the observer is an elderly person, because of farsightedness due to old age (presbyopia), the observer sometimes finds it difficult to focus at a display image. In such case, an observed image becomes an image in defocus state. This means that a pupil function of an optical system (eye) includes a wavefront aberration, or defocus in this case.

If the pupil function includes defocus (wavefront aberration), the pupil function is expressed by the following expression (6).

$$p ( u , v ) = circ [ \sqrt{\frac{{u}^{2} + {v}^{2}}{{( a / λ f )}^{2}}} ] exp [ - j kw ( u , v ) ] \qquad ( 6 )$$

Here, “a” denotes a half pupil-diameter, λ denotes a wavelength, f denotes a focal length of the optical system, and w(u, v) denotes the wavefront aberration.

Moreover, circ[x] is

circ[x]=1 for x≦1, circ[x]=0 for 0<x

By the way, the pupil function which includes defocus becomes a complex number, and includes phase information.

As it has been described above, CTF is obtained by Fourier transform of IRF. On the other hand, CTF is a pupil function. Therefore, in the expression (6), p(u, v) can be replaced by Fh(u, v).

From expression w(u, v)=(u²+v²)Δz/2f², the following expression holds true.

$$Fh ( u , v ) = circ [ \sqrt{\frac{{u}^{2} + {v}^{2}}{{( a / λ f )}^{2}}} ] exp [ - j \frac{π ( {u}^{2} + {v}^{2} )}{λ {f}^{2}} Δ z ] \qquad ( 7 )$$

As it has been described above, from expression (5), an image formation in a spatial frequency domain will be expressed as the following expression (8).

Fi(u, v)=Fh(u, v)Fo(u, v) (8)

In expression (8), when the pupil function Fh(u, v) includes defocus, the observed image becomes an image in the state of being focused. Therefore, in the first embodiment, correction expressed by the following expression (9), in other words, the correction of the display image (amplitude) o(u, v) is carried out by the pupil function h(u, v) which includes defocus, and generates a pre-corrected image o′(x, y).

Fo′(u, v)=Fo(u, v)/Fh(u, v) (9)

o′(x, y) is obtained by an inverse Fourier transform of Fo′(u, v). Moreover, o′(x, y) is a complex number, an absolute value is amplitude, and an argument is phase.

When the pre-corrected image o′(x, y) is used, i′(x, y) is expressed by the following expression (10).

$$\begin{matrix}{Fi}^{′} ( u , v ) = Fh ( u , v ) {Fo}^{′} ( u , v ) \\ = Fh ( u , v ) Fo ( u , v ) / Fh ( u , v ) \\ = Fo ( u , v )\end{matrix} \qquad ( 10 )$$

As it is evident from expression (10), since the observed image i′(x, y) becomes the display image O(x, y)=|o(x, y)|², an image same as at the time when there is no wavefront aberration is obtained.

In this manner, in the first embodiment, by correcting the display image by inverse number of the coherent transfer function of the defocus, it is possible to prepare a pre-corrected image in which diopter adjustment is possible.

However, when an original image (display image) is divided simply by the CTF(coherent transfer function), a restored image can be degraded with increased noise on the contrary. In such case, it is preferable to use the Wiener filter. The Wiener filter is expressed by the following expression (11).

$$t ( u , v ) = \frac{1}{Fh ( u , v ) ( 1 + \frac{\vert 1 \vert}{φ {\vert Fh ( u , v ) \vert}^{2}} )} \qquad ( 11 )$$

Here, φ is a signal to noise ratio.

The pre-corrected image o″(u, v) is easily obtained by inverse Fourier transfer of the following expression (12).

Fo″(u, v)=t(u, v)Fo(u, v) (12)

Data of the pre-corrected image o″(u, v) becomes a complex number. An absolute value of this complex number indicates the amplitude component and an argument indicates the phase component.

Next, the method of generating corrected image data and the display apparatus will be described below more concretely.

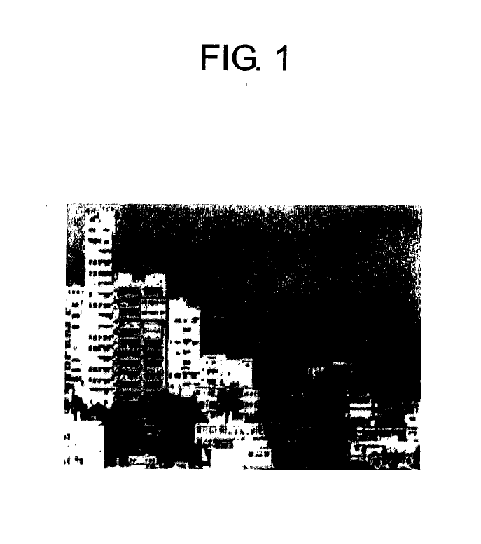

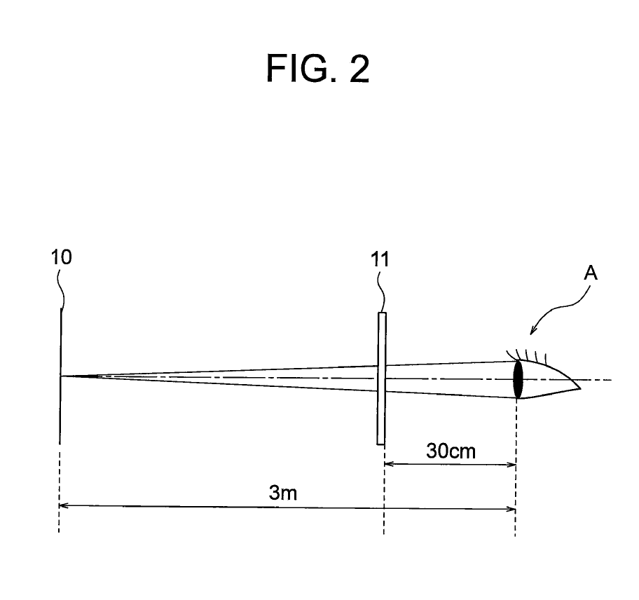

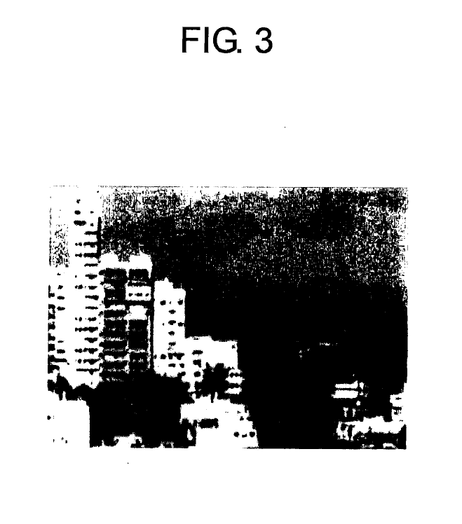

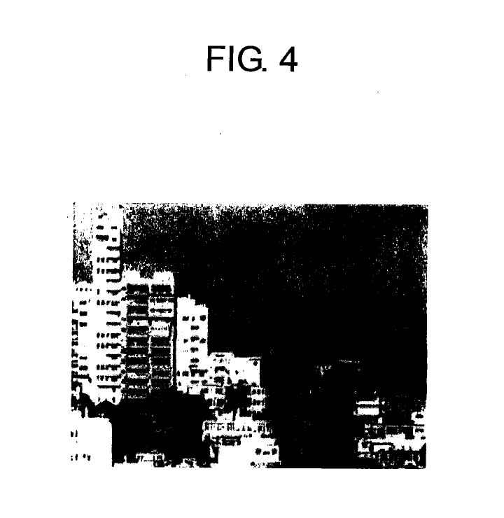

FIG. 1 is a diagram showing an example of a display image. FIG. 2 is a diagram showing a focal position of an observer having farsightedness due to old age and a distance of distinct vision at which the image shown in FIG. 1 is placed. FIG. 3 is a diagram showing a defocus image, which the observer having farsightedness due to old age shown in FIG. 2 sees when the image shown in FIG. 1 is placed at the distance of distinct vision. In other words, it is an image when a farsighted observer A (focal position 10 (FIG. 2)) who cannot focus at a distance except beyond 3 m has seen a display image 11 in FIG. 1 placed at the distance of distinct vision of 30 cm (FIG. 2). It is clear that the image is blurred. FIG. 4 is a diagram showing an image when the observer having farsightedness due to old age has seen a pre-corrected image which has been generated by the Wiener filter based on the image shown in FIG. 1. It is clear that the blurring has been corrected favorably. By seeing the pre-corrected image, even the observer having farsightedness due to old age who cannot focus at the distance of distinct vision is able to see an image in focus.

Data of the pre-corrected image by the Wiener filter is a complex number, and for displaying accurately, it is necessary to display both the amplitude information and the phase information simultaneously.

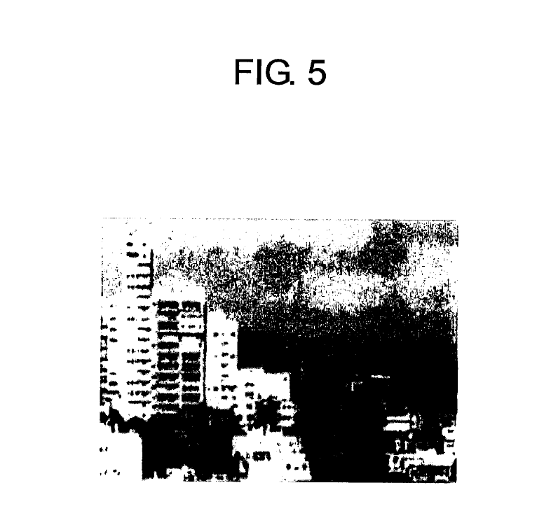

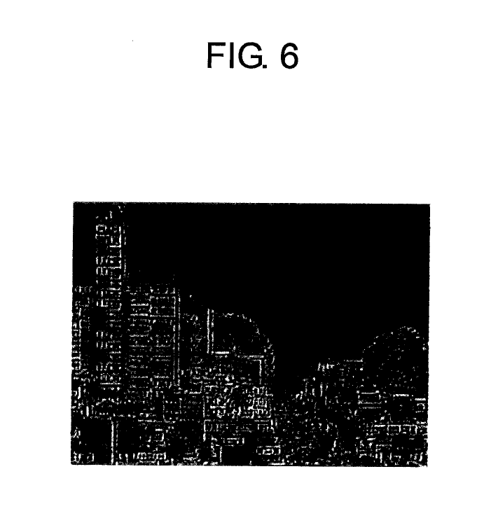

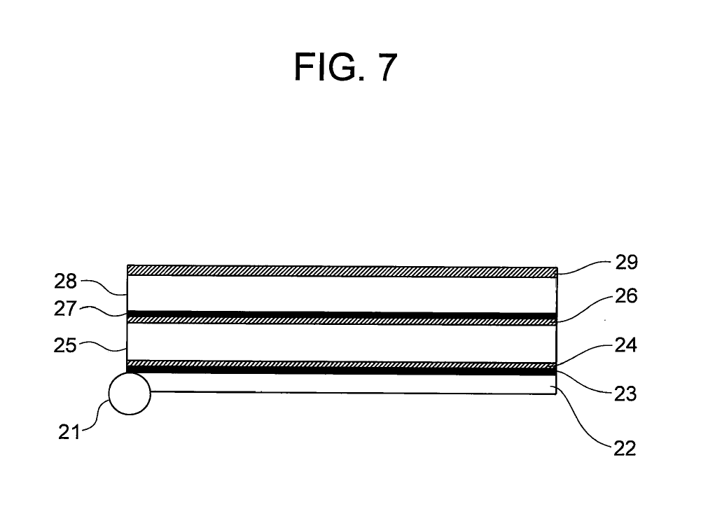

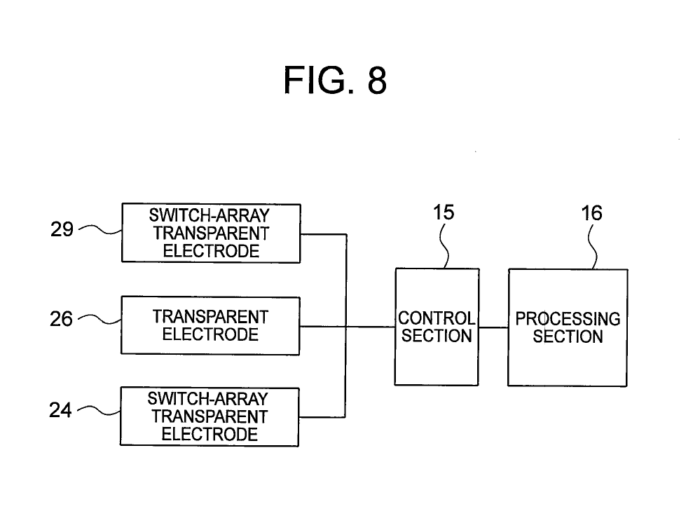

Display of the amplitude information and the phase information will be described below. FIG. 5 is a diagram showing the amplitude component of the pre-corrected image. FIG. 6 is a diagram showing the phase component of the pre-corrected image. The phase is indicated by shading. FIG. 7 is a side view showing an arrangement of a liquid-crystal device which can display the amplitude component and the phase component simultaneously. FIG. 8 is a block diagram showing a configuration of a control system of the liquid-crystal device shown in FIG. 7.

The liquid-crystal device shown in FIG. 7 includes a light source 21, a light guide plate 22, a polarizing plate 23, a switch-array transparent electrode 24, a liquid crystal 25, a transparent electrode 26, a polarizing plate 27, a liquid crystal 28, and a switch-array transparent electrode 29. Components from the light guide plate 22 up to the switch-array transparent electrode 29 are stacked in the abovementioned order. In FIG. 7, a color filter for color display is omitted.

Moreover, as shown in FIG. 8, the switch-array transparent electrode 24, the transparent electrode 26, and the switch-array transparent electrode 29 are connected to a control section 15, and the control section 15 is connected to a processing section 16.

The processing section 16 generates corrected image data which include the amplitude information and the phase information by the abovementioned procedure. The amplitude information and the phase information of the corrected image data which have been generated by the processing section 16 are controlled by the control section 15, and are displayed on the liquid-crystal display device (display section) shown in FIG. 7.

Light from the light source 21 passes through the light guide plate 22, becoming linearly polarized light by the light guide plate 22, and is incident on the liquid crystal 25. When an electric field is impressed between the switch-array transparent electrode 24 and the transparent electrode 26, an orientation of the liquid crystal 25 becomes same as a direction of voltage, and a direction of polarization of light changes. Therefore, an amount of light passing through the polarizing plate 27 is modulated by the electric field which has been impressed. The switch-array transparent electrode 24 is capable of controlling the electric field impressed on each pixel, and is capable of displaying the amplitude information by controlling the electric field.

Light which has emerged from the polarizing plate 27 is incident on the liquid crystal 28. The liquid crystal 28 is oriented such that an effective refractive index changes according to the voltage, and is capable of modulating a phase of light which has passed, by the voltage which has been applied to the switch-array transparent electrode 29. Therefore, the liquid crystal 28 is capable of displaying the phase information. Each of the switch-array transparent electrodes 24 and 29 is capable of controlling the electric field impressed on each pixel, and the transparent electrode 26 is an electrode which is common to the switch-array transparent electrodes 24 and 29. In this manner, it is possible to display the amplitude information and the phase information simultaneously with a simple arrangement.

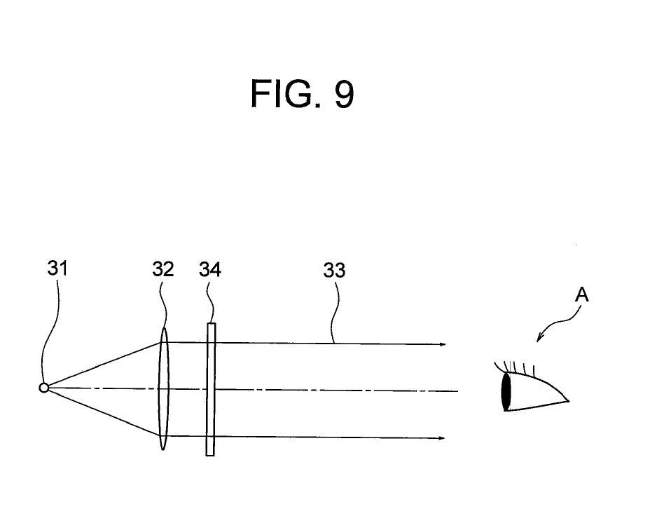

FIG. 9 is a conceptual diagram showing a state in which coherent image formation is realized.

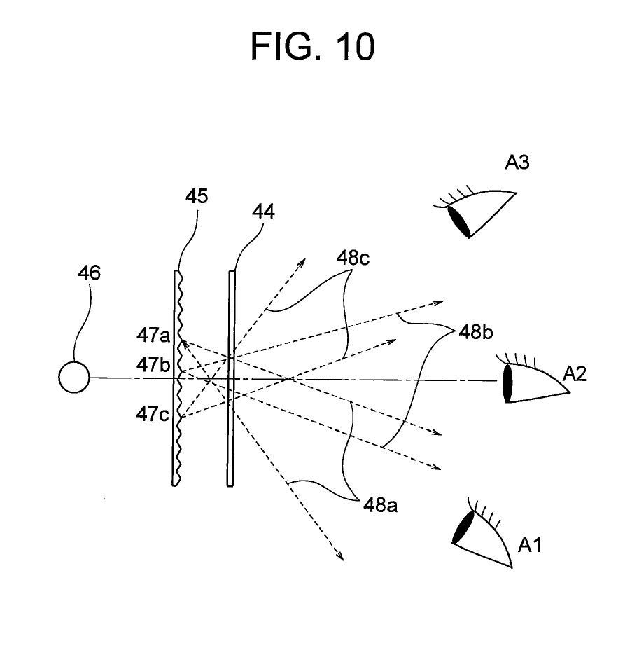

As the state in which the coherent image formation is realized, a case in which an emerged light 33 from a point light source 31 becomes a substantially parallel light by a lens 32, and is incident on a pupil of an observer A after passing through a display device 34 which is capable of displaying the amplitude information and the phase information as shown in FIG. 9, can be taken into consideration. However, in this case, since a direction of viewing of the observer A is restricted, it is desirable to use a scattering plate 45 (diffuser plate) shown in FIG. 10.

FIG. 10 is a conceptual diagram showing a formation with a scattering plate.

In the formation shown in FIG. 10, light from a light source 46 is scattered at each point (such as scattering points 47a, 47b, and 47c) of the scattering plate 45. Light beams 48a, 48b, and 48c generated by scattering at the scattering points 47a, 47b, and 47c pass through a display device 44 which is capable of displaying the amplitude information and the phase information. By such formation, the observer is capable of observing information of the display device 44 from each of directions A1, A2, and A3.

With the method of generating corrected image data and the display apparatus according to the first embodiment, even a person who cannot focus at a display position is also capable of viewing a display in focus by displaying the pre-corrected image data consists of the amplitude information and the phase information, on the display device 44 as a display section.

Moreover, in the method of generating corrected image data and the display apparatus according to the first embodiment, even a farsighted person due to an old age is capable of viewing the display in focus without putting on or taking off reading glasses.

Furthermore, according to the method of generating corrected image data and the display apparatus according to the first embodiment, it is possible to reduce strain on eyes of a farsighted observer, and the observer is capable of observing without using reading glasses or any other optical member. Moreover, it is possible to realize a flat-panel display in which diopter adjustment according to eyesight of the observer is possible.

### Second Embodiment

A diameter of a pupil of an eye is normally about 2 mm to 3 mm, and information of a point is considered to be displayed in a range from 1.8 mm to 2.7 mm diameter on a display device (refer to FIG. 2). Therefore, it is sufficient that coherent image formation with the amplitude information and the phase information displayed on the display device comes about in the abovementioned range. Or, even with about half of it, sufficient effect is observed. Therefore, it is preferable that a coherent illuminated area (region) is equal to 1 mm or is more than 1 mm.

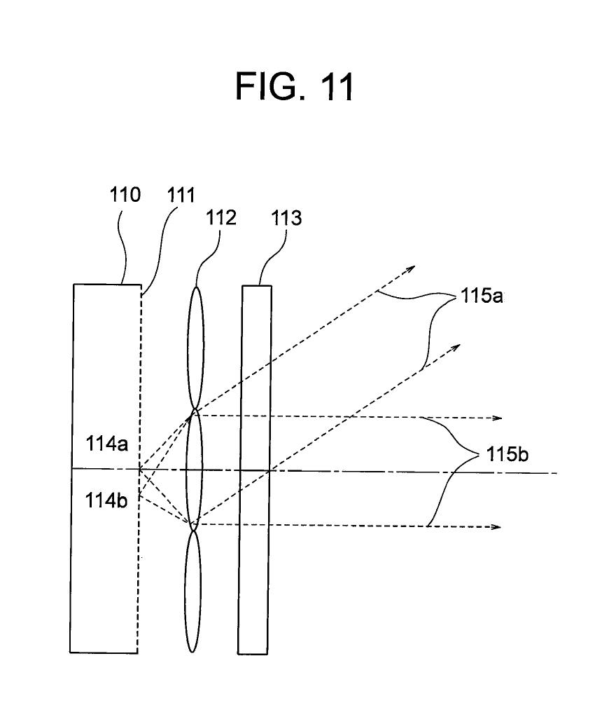

FIG. 11 is a diagram showing an arrangement of a display apparatus according to a second embodiment. The display apparatus shown in FIG. 11 includes a light guide plate 110, a pinhole array 111, a micro lens array 112, and a display device 113, and generates an arbitrary coherent illuminated area.

The pinhole array 111 is disposed on one surface of the light guide plate 110. The pinhole array 111 is formed by disposing pinholes 114a and 114b of 5 μm diameter at an interval of 10 μm.

The micro lens array 112 is disposed at a position facing the pinhole array 111. A distance between the pinhole array 111 and the micro lens array 112 is 1 mm. A diameter of a lens in the micro lens array 112 corresponds to the coherent illuminated area, and the diameter of 1 mm or more than 1 mm is preferable.

Furthermore, the display device 113 is disposed at a position facing the micro lens array 112. The display device 113 is disposed at a position away from the micro lens array 112 by about 1 mm, and displays the amplitude information and the phase information. The display section, the control section, and the processing section shown in FIG. 7 and FIG. 8 are used as the display device 113.

In the display device shown in FIG. 11, light scattered at the pinholes 114a and 114b becomes light beams 115a and 115b, and is observed by the observer. Since a wavefront of a point light source formed by each of the pinholes 114a and 114b becomes coherent illumination on the display device 113, the coherent image formation is achieved, and can be seen in a wide angle of view.

Moreover, it is preferable to use a solid light source, particularly an LED, for the light source. It is preferable to use LEDs of red, green, and blue for color display.

The second embodiment is an example of a method for forming the coherent area.

### Third Embodiment

Since a normal light source is an incoherent light source, it is necessary to create conditions for the coherent image formation by using an arrangement such as the point light source 31 in FIG. 9 or the pinholes 114a and 114b in FIG. 11. Whereas, a coherent light source such as LD (laser diode), is equivalent to the point light source, and it is easy to create the conditions for the coherent image formation. However, with the same arrangement, it is not possible to observe except in one direction as in FIG. 9. Therefore, it is necessary to devise a method which enables to observe from all directions by using the scattering plate 45 as in FIG. 10. Additionally, in this case, it is necessary to be careful about a point that light scattered at each of the light scattering points 47a, 47b, and 47c is mutually coherent, and there may be interference. This point differs from the second embodiment. When the scattering plate 45 is used, there is a possibility of occurrence of granular pattern with a strong contrast called speckle. Bye the way it is necessary to distinguish the difference between coherence and incoherence of the light source from the difference between the coherent image formation and the incoherent image formation.

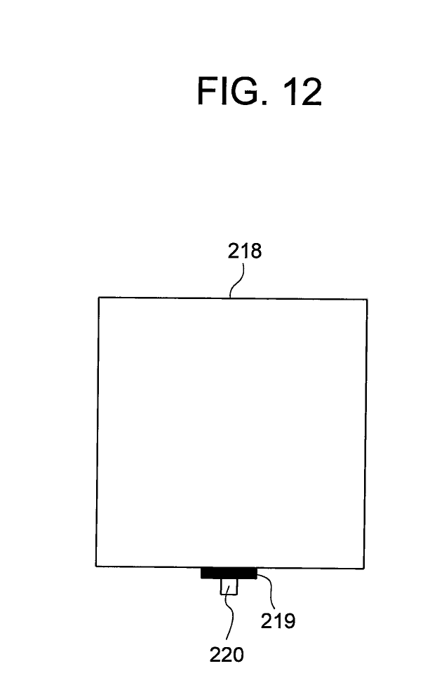

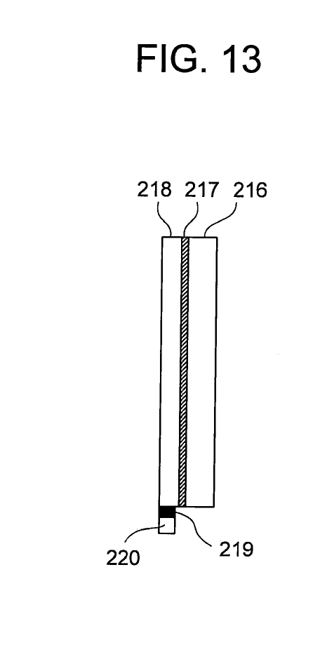

FIG. 12 is a front view showing an arrangement of a display apparatus according to a third embodiment of the present invention. FIG. 13 is a side view showing an arrangement of the display apparatus according to the third embodiment. The display apparatus shown in FIG. 12 and FIG. 13 is an example in which a laser such as a LD having a long coherent length is used.

The display apparatus shown in FIG. 12 and FIG. 13 includes a display device 216, a scattering plate 217 (diffuser plate), a light guide plate 218, a deflector 219 (AOD) (acousto-optical deflector), and an LD 220.

Laser light generated at LD 220 is deflected by the deflector 219, and is irradiated to the display device 216 which is capable of displaying an amplitude and a phase, via the light guide plate 218 and the scattering plate 217. The light generated at the LD 220 is spread uniformly at the light guide plate 218, and is able to illuminate the display device 216 uniformly by the diffuser plate 217.

Since the coherent length of the light generated at the LD 220 is long, there is coherence. Therefore, speckle noise with granular pattern is susceptible to arise. When there is speckle noise, information to be displayed by the display device 216 is harmed remarkably. To eliminate the speckle noise, a speckle pattern is averaged by rotating the scattering plate usually, and the speckle noise disappears practically. However, in a thin flat-panel display (FPD), rotating the scattering plate is not practical. Therefore, in the display apparatus of the third embodiment, an optical path length is changed by deflecting a laser beam of illuminating light by using the deflector 219 as a speckle reducing mechanism. Accordingly, the speckle pattern moves and is averaged.

Apart from this, for elimination of the speckle noise, a method of shifting a wavelength of the LD is also effective. In this manner, it is preferable to have a function of reducing speckle. LDs of red, green, and blue colors are to be used for color display.

As it has been described above, the method of generating corrected image data and the display apparatus according to the present invention is useful in a mobile equipment such as an electronic book, a digital camera, and a mobile telephone which include an FDP.

1. A method of generating corrected image data, comprising:
generating a pre-corrected image data consists of amplitude information and phase information.

2. The method of generating corrected image data according to claim 1, wherein a correction function which is used for generating the pre-corrected image data is a correction function of an optical system.

3. The method of generating corrected image data according to claim 2, wherein the correction function is inverse number of a transfer function of defocus.

4. The method of generating corrected image data according to claim 2, wherein the correction function is the Wiener filter of a transfer function of defocus.

5. The method of generating corrected image data according to claim 2, wherein the optical system is an ocular optical system.

6. A display apparatus comprising:
a processing section which generates pre-corrected image data which include amplitude information and phase information, by the method of generating corrected image data according to claim 1; and
a display section which displays the amplitude information and the phase information of the corrected image data which have been generated.

7. The display apparatus according to claim 6, wherein the display section is a display device composed of a liquid crystal.

8. The display apparatus according to claim 7, wherein the display device is illuminated via a scattering plate.

9. The display apparatus according to claim 7, wherein a coherent illuminated area is larger than 1 mm.

10. The display apparatus according to claim 7, wherein a light source of the display device is a solid light source.

11. The display apparatus according to claim 10, wherein the light source is an LED.

12. The display apparatus according to claim 10, wherein the light source is a laser.

13. The display apparatus according to claim 12, comprising:
a speckle reducing mechanism which reduces speckle.
